(19) United States
(12) Patent Application Publication
(10) Pub. No.: US 2005/0196608 A1
(43) Pub. Date: Sep. 8, 2005

(54) Sound damping adhesive

(76) Inventors: Dominique Wouters, Gierle (BE); Graham Yeadon, Marbach SG (CH)

Correspondence Address: Armand P. Boisselle;Renner, Otto, Boisselle & Sklar, LLP, Nineteenth Floor, 1621 Euclid Avenue, Cleveland, OH, 44115, US

(21) Appl. No.: 11/101,758

(22) Filed: Apr. 8, 2005

Related U.S. Application Data
(63) Continuation-in-part of application No. 10/961,873, filed on Oct. 8, 2004.
(60) Provisional application No. 60/509,796, filed on Oct. 8, 2003.

(51) Int. Cl. C08F 22/10

(52) U.S. Cl. 428/355 R

(57) ABSTRACT

Acrylic based adhesives and constructions are described and claimed. The adhesives comprise on a copolymerized basis, (A) from about 50 to about 90% by weight of at least one alkyl acrylate, alkyl methacrylate, and mixtures thereof, wherein the alkyl group contains at least four carbon atoms, (B) from about 10% to about 30% by weight of at least one ethylenically unsaturated carboxylic acid or anhydride monomer, and (C) from about 0 to about 40% by weight of a monoethylenically unsaturated comonomer selected from styrene and substituted styrenes; alkyl acrylates and alkyl methacrylates containing less than 4 carbon atoms in the alkyl group; vinyl acetate; N-vinyl lactams; acrylonitrile; glycidyl containing monomers; hydroxyalkyl, alkoxyalkyl and phenoxyalkyl acrylates and methacrylates wherein the hydroxyalkyl, alkoxyalkyl and phenoxyalkyl groups contain from 2 to about 12 carbon atoms in the alkyl groups and from 1 to about 6 carbon atoms in the alkoxy groups; cyclic and heterocylic acrylates and methacrylates; and mixtures of two or more thereof. The acrylic based adhesives of the invention exhibit desirable sound/vibration damping properties.

### CROSS REFERENCE TO RELATED APPLICATIONS

This application is a continuation-in-part of application Ser. No. 10/961,873 filed on Oct. 8, 2004 which claims priority to provisional application Ser. No. 60/509,796 filed on Oct. 8, 2003, the contents of which are hereby incorporated by reference in their entirety.

### FIELD OF THE INVENTION

The present invention is directed to acrylic based adhesive compositions including pressure sensitive adhesives, that exhibit sound/vibration damping properties at elevated temperatures. The invention also is directed to sound/vibration damping constructions.

### BACKGROUND OF THE INVENTION

Sound and vibration damping adhesives are known for use in the automotive, electronics and appliance industries. As pressure sensitive adhesives are visco-elastic materials, they exhibit sound and vibration damping properties. Sound damping acrylate pressure sensitive adhesives generally are formulated to provide optimal sound damping at room temperature or near room temperature. Because the temperature at which these adhesive are used can rise above room temperature, there is a need for an adhesive with optimal damping properties at higher temperatures.

### SUMMARY OF THE INVENTION

The present invention relates to a vibration and/or sound vibration damping acrylic based adhesives, and particularly to self crosslinked acrylic based adhesives comprising, on a copolymerized basis,
(A) from about 50 to about 90% by weight of at least one alkyl acrylate, alkyl methacrylate, and mixtures thereof, wherein the alkyl group contains at least four carbon atoms,
(B) from about 10% to about 30% by weight of at least one ethylenically unsaturated carboxylic acid or anhydride monomer, and
(C) from about 0 to about 40% by weight of a monoethylenically unsaturated comonomer selected from styrene and substituted styrenes; alkyl acrylates and alkyl methacrylates containing less than 4 carbon atoms in the alkyl group; vinyl acetate; N-vinyl lactams; acrylonitrile; glycidyl containing monomers; hydroxyalkyl, alkoxyalkyl and phenoxyalkyl acrylates and methacrylates wherein the hydroxyalkyl, alkoxyalkyl and phenoxyalkyl groups contain from 2 to about 12 carbon atoms in the alkyl groups and from 1 to about 6 carbon atoms in the alkoxy groups; cyclic and heterocylic acrylates and methacrylates; and mixtures of two or more thereof.

The adhesives of the present invention provide sound and vibration damping at elevated temperatures such as at room temperature and above, and at high frequencies, typically from about 100 Hz to about 10 kHz. The damping acrylic based adhesive can be laminated onto substrates at room temperature to form constructions, without the need for special equipment or processes, such as radiation curing or in-situ curing at high temperatures. However, elevated temperatures and pressures may be used to form a strong bond. The substrates may be polymeric substrates, paper or metal, with or without an overlying coating, with the adhesive adhered to or laminated on one or both sides of the substrate.

### DETAILED DESCRIPTION OF THE INVENTION

The self-crosslinked acrylic based adhesives of the present invention comprise acrylic copolymers prepared from self-crosslinkable polymerizable mixtures which comprise, on a copolymerized basis,
(A) from about 50 to about 90% by weight of at least one alkyl acrylate, alkyl methacrylate, and mixtures thereof, wherein the alkyl group contains at least four carbon atoms,
(B) from about 10% to about 30% by weight of at least one ethylenically unsaturated carboxylic acid or anhydride monomer, and
(C) from about 0 to about 40% by weight of a monoethylenically unsaturated comonomer selected from styrene and substituted styrenes; alkyl acrylates and alkyl methacrylates containing less than 4 carbon atoms in the alkyl group; vinyl acetate; N-vinyl lactams; acrylonitrile; glycidyl containing monomers; hydroxyalkyl, alkoxyalkyl and phenoxyalkyl acrylates and methacrylates wherein the hydroxyalkyl, alkoxyalkyl and phenoxyalkyl groups contain from 2 to about 12 carbon atoms in the alkyl groups and from 1 to about 6 carbon atoms in the alkoxy groups; cyclic and heterocylic acrylates and methacrylates; and mixtures of two or more thereof.

In one embodiment, the polymerizable mixture of monomers comprise from about 60 to 85% by weight of alkyl acrylates, alkyl methacrylates, and mixtures of two or more thereof wherein the alkyl groups contain at least 4 carbon atoms. In another embodiment, the alkyl groups contain from about 4 to about 12 or 18 carbon atoms. Examples of alkyl acrylates containing 4 or more carbon atoms which are useful in the present invention include butyl acrylate, sec-butyl acrylate, methyl butyl acrylate, 4-methyl-2-pentyl acrylate, 2 ethylhexyl acrylate, isooctylacrylate, isodecyl acrylate, dodecyl acrylate, (lauryl acrylate), etc. Examples of alkyl methacrylates useful in the present invention include butyl methacrylate, sec-butyl methacrylate, methyl butyl methacrylate, 4-methyl-2-pentyl methacrylate, 2 ethylhexyl methacrylate, isooctyl methacrylate, isodecyl methacrylate, dodecyl methacrylate, (lauryl methacrylate), hexadecyl methacrylate, octadecyl methacrylate, etc. Mixtures of two or more of the above acrylates and methacrylates also can be utilized in the polymerizable mixture.

The copolymerizable mixture also comprises from about 10% to about 30% by weight of at least one ethylenically unsaturated carboxylic acid or anhydride monomer. In another embodiment, the polymerizable mixture contains from about 15 to about 25% or 30% by weight of at least one ethylenically unsaturated carboxylic acid or anhydride monomer. Specific examples of ethylenically unsaturated carboxylic acid monomers include acrylic acid, methacrylic acid, maleic acid, maleic anhydride, itaconic acid, fumaric acid, crotonic acid, etc., and dimers thereof such as the dimer of acrylic acid. An example of a useful dimer is BETA-C available from Bimax Chemicals Limited. BETA-C is identified as a beta-carboxyethyl acrylate or 2-carboxyethyl acrylate and is characterized by the formula CH₂═CHC(O)OCH₂CH₂COOH.

In one embodiment, the polymerizable mixtures may contain up to about 40% by weight of another ethylenically unsaturated comonomer. In another embodiment, the polymerizable mixture may contain from about 0.5 to about 40% by weight or 0.5 to about 20 or 25% by weight of the comonomer. The monoethlenically unsaturated comonomer which may be present in the polymerizable mixtures are selected from styrene and substituted styrenes; alkyl acrylates and alkyl methacrylates containing less than 4 carbon atoms in the alkyl group; vinyl acetate; N-vinyl pyrrolidones; acrylonitrile; glycidyl containing monomers; hydroxyalkyl, alkoxyalkyl and phenoxyalkyl acrylates and methacrylates wherein the hydroxyalkyl, alkoxyalkyl and phenoxyalkyl groups contain from 2 to about 12 carbon atoms in the alkyl groups and from 1 to about 6 carbon atoms in the alkoxy groups; cyclic and heterocylic acrylates and methacrylates; and mixtures of two or more thereof.

Specific examples of styrenes which are useful include styrene, alpha-methyl styrene, 3-methyl styrene, 4-methyl styrene, etc. Examples of alkyl acrylates and alkyl methacrylates containing less than 4 carbon atoms in the alkyl group which are useful in the mixtures of the present invention include methyl acrylate, methyl methacrylate, ethyl acrylate, ethyl methacrylate, propyl acrylate and propyl methacrylate, etc. The monoethylenically unsaturated comonomer (C) useful in one embodiment of preparing the copolymer adhesives of the present invention also may be vinyl acetate, acrylonitrile, and glycidyl containing monomers. Examples of glycidyl monomers include glycidyl acrylate, glycidyl methacrylate, allyl glycidyl ether and mixtures thereof.

Hydroxyalkyl acrylates and hydroxyalkyl methacrylates may be included in the polymerizable mixtures. The hydroxyalkyl groups may contain from about 2 to about 12 or more carbon atoms, and examples include 2-hydroxyethyl acrylate, 2-hydroxyethyl methacrylate, 3-hydroxypropyl acrylate, etc.

The alkoxy alkyl acrylates and methacrylates which may be included in the polymerizable mixtures include those containing from 1 to about 6 carbon atoms in the alkoxy group, and from 2 to about 12 carbon atoms in the alkyl groups. In another embodiment the alkyl groups contain from 2 to about 6 carbon atoms. Examples of useful alkoxy alkyl acrylates and methacrylates include: 2-methoxy ethyl acrylate; 2-methoxy ethyl methacrylate; 2-ethoxyethyl acrylate; 2-ethoxyethyl methacrylate; 3-methoxypropyl acrylate; 3-methoxypropyl methacrylate, etc. Examples of phenoxyalkyl acrylates include 2-phenoxyethyl acrylate; 3-phenoxypropyl acrylate; 2-phenoxyethyl methacrylate; 3-phenoxypropyl methacrylate, etc.

Examples of useful cyclic acrylates and methacrylates include: cyclohexyl acrylate; cyclohexyl methacrylate; isobornyl acrylate; isobornyl methacrylate; 3,3,5-trimethylcyclohexyl acrylate; 3,3,5-trimethylcyclohexyl methacrylate; etc. Examples of heterocyclic acrylates include: tetrahydrofurfuryl acrylate; tetrahydrofurfuryl methacrylate, etc.

The monoethylenically unsaturated comonomer (C) may be an N-vinyl lactam. Examples of such monomers include N-vinyl pyrrolidone, N-vinyl caprolactam, 1-vinyl-2-piperidone, 1-vinyl-5-methyl-2-pyrollidone, etc.

In one embodiment, the polymerizable mixture may also contain a chelate crosslinking agent. The chelate crosslinking agent may be present in amounts of from about 0.01 to about 1% by weight based on the total dry weight of the monomers and comonomers. The chelating agent may be added to the polymerization mixture after it is cooled or the agent may be added to the mixture directly before coating on a substrate.

The chelate crosslinking agent may be an organometallic agent of chelated metals that possess multiple stable oxidation states such as metal diketonates or derivatives thereof. Examples of such organometallic agents include aluminum acetylacetonate, cobalt (III) acetylacetonate, cobalt (II) acetylacetonate, zirconium acetylacetonate, titanium acetylacetonate, chromium acetylacetonate, etc. Other useful agents include isocynates and polyaziridines which are known in the art. These two types of agents are added directly before the adhesive is applied to a substrate because of a very short pot life.

In one embodiment, the polymerizable mixture is free of phenolic antioxidants. In another embodiment, the copolymerizable mixtures used to form the copolymer adhesives of the present invention also are free of epoxy containing monomers.

In yet another embodiment the polymerizable mixtures are free of internal crosslinking agents such as polyfunctional monomers including, e.g., ethylene glycol di(meth)acrylate, pentaerythritol tri(meth)acrylate and tetramethylomethane, tetra(meth)acrylate. The term “free of” as used herein and in the claims is used to indicate that these materials are not intentionally added to the polymerizable mixtures. However, the materials may be present in amounts of less than 0.1% by weight as impurities in the monomers and comonomers used in the polymerizable mixtures.

In one embodiment, the copolymer adhesives are prepared from mixtures of monomer and comonomers which are self crosslinking. The term “self crosslinking” means the upon exposure to ambient conditions, a covalently crosslinked network is formed without any applied energy. For example, the mixture can be polymerized without any heat or radiation being applied to the polymerizable mixture. In one embodiment, removal of any solvent from a solution of the copolymerizable monomers and comonomers is sufficient to effect self crosslinking.

Solvents which may be utilized in the formation of the copolymer include any suitable solvent in which the monomers are soluble. In one embodiment, the solvents utilized include tetrahydrofuran, toluene, xylene, hexane, heptane, cyclohexane, cyclohexanone, methylene chloride, isopropanol, ethanol, ethyl acetate, butyl acetate, isopropyl acetate, etc.

Initiators may be included in the polymerizable mixtures to assist in polymerization of the monomers. The type of initiator used depends on the polymerization process. Photo initiators which are useful for polymerizing the monomer mixtures with ultraviolet radiation include benzoin ethers such as benzoin methyl ether and benzoin isopropyl ether, substituted benzoin ethers such as 2-methyl-2-hydroxy propiophenone, substituted acetophenones such as 2,2-diethoxy acetophenone and 2-2-dimethoxy-2-phenyl acetophenone, substituted alpha ketols such as 2-methyl-2-hydroxy propiophenone, substituted acetophenones such as 2,2-diethoxy-acetophenone and 2,2-dimethoxy-2-2-phenylacetophenone, substituted alpha ketols such as 2-methyl-2-hydroxy propiophenone, aromatic sulfonyl chlorides such as 2-naphthalene sulfonyl chloride and photo active oximes such as 1-phenyl-1,2-propanedione-2-(O-ethoxy carbonyl)oxime. An example of a commercially available photoinitiator is Irgacure 651 available from Ciba-Geigy Corporation having the formula, 2,2-dimethoxy-1,2-diphenyl ethane-1-one. In one embodiment, the photo initiators are present in amounts of from about 0.005 to 5% by weight, and from about 0.01 to 1% by weight based on the combined weight of the monomers. Examples of suitable thermal initiators include AIBN (azobisisobutyronitrile) and peroxides.

The copolymer adhesives of the present invention also can be prepared utilizing other known polymerization methods. Addition polymerization can be conducted, for example, by the solution polymerization method, emulsion polymerization method, photo polymerization method using electron beams, ultraviolet rays, etc., or a combination of two or more of these methods. Emulsion polymerization is another useful process, and the polymerization reaction also can be performed as a solvent polymerization, a bulk or hot melt polymerization, irradiation-induced polymerization, etc. In one embodiment, an acrylic emulsion PSA is prepared by allowing the monomers to react in the presence of suitable polymerization initiators and emulsifiers (surfactants). In some embodiments, one or more activators and/or chain transfer agents (or other molecular weight regulators) also are employed in the polymerization reaction.

In one embodiment, the polymerizable monomer mixture also may contain a crosslinking agent or a combination of crosslinking agents. When utilized, the crosslinking agent may be present in an amount of from about 0.005 to about 3 weight percent or from about 0.05 to about 2 weight percent based on the combined weight of the monomers.

Useful crosslinking agents include substituted triazines such as 2,4-bis(trichloromethyl)-6-(4-methyoxy phenyl)-s-triazine, 2,4-bis(trichloromethyl)-6-(3,4-dimethoxy phenol)-s-triazine, and the chromophore-substituted halo-s-triazines disclosed in U.S. Pat. Nos. 4,329,384 and 4,330,590. Other useful crosslinking agents include multifunctional alkyl acrylate monomers such as trimethyl propane tri acrylate, pentaerythritol tetra acrylate, 1,2-ethylene glycol diacrylate, 1,4-butene diol diacrylate, 1,6-hexane diol diacrylate and 1,12 dodecanol diacrylate.

Non-limiting examples of emulsifiers which may be utilized for emulsion polymerization include both anionic and non-ionic surfactants and stabilizers including, alkyl phenol ethoxylates such as nonyl phenol ethoxylate (a non-ionic surfactant sold as POLYSTEP F9 by Stepan Company Inc. of Winnetka, Ill.), alkyl aryl sulfonates such as sodium dodecyl benzene sulfonate (an anionic surfactant sold as Rotacal DS 10 by Rhodia of Cranbury, N.J.) and Rotacal A246L (an alpha olefin sulfonate available from Rhodia), Disponil FES 77, a lauryl ether sulfate surfactant available from Henkel of America, Inc. King of Prussia Pa., TSPP (sodium pyrophosphate) available from JP Baker, Phillipsburg, N.J., and Aerosol OT-75, a sodium dioctyl sulfo succinate surfactant available from American Cyanimide, Wayne, N.J. The emulsifiers are employed in an amount sufficient to form a stable monomer emulsion.

The following examples illustrate the preparation of the copolymers of the present invention. Unless otherwise indicated in the examples, and elsewhere in the written description and the claims, all parts and percentages are by weight, temperatures are in degrees centigrade and pressure is at or near atmospheric pressure.

### EXAMPLE 1

A monomer mixture (980.5 grams) is prepared which contains 85% by weight of 2-ethyl hexyl acrylate, 15% by weight of acrylic acid. Ethyl acetate (382 grams), is heated in a reactor to the reflux temperature. A first initiator solution containing 9.8 grams of ethyl acetate and 0.74 grams of 2,2′-azo bis (2-methyl propionitrile), and 294 grams of the monomer mixture are added to the reactor. When the contents of the reactor return to reflux, an additional 686.5 grams of the monomer mixture and a second initiator solution containing 343.2 grams of ethyl acetate and 1.5 grams of 2,2′-azo bis (2-methyl propionitrile) are added at a constant rate over a period of about 2 hours. At the end of the monomer and initiator additions, the contents of the reactor are maintained at a gentle reflux for one hour whereupon a third initiator solution containing 139 grams of ethyl acetate and 1.47 grams of 2,2′-azo bis (2-methyl propionitrile) are added over 30 minutes. After addition of the third initiator solution, the reactor contents are maintained in a gentle reflux for 2 hours whereupon additional ethyl acetate (441.2 grams) is added. The contents are cooled, and the desired copolymer solution is obtained. Aluminum acetylacetonate (0.3% w based on dry weight of the monomers and comonomers) may be added to the solution after cooling or added to the solution directly before coating on a substrate.

### EXAMPLES 2-11

The procedure of Example 1 is repeated utilizing the monomer mixture described in Table I.

TABLE I

| | Examples 2-14 |
|---|---|
| Example | Monomer Mixture (% w) |
| 2 | 80% 2 ethyl hexyl acrylate (EHA) |
| | 20% acrylic acid (AA) |
| 3 | 75% EHA |
| | 25% AA |
| 4 | 80% butyl acrylate (BA) |
| | 20% AA |
| 5 | 75% BA |
| | 25% AA |
| 6 | 85% EHA |
| | 10% methacrylic acid (MAA) |
| | 5% acrylic acid |
| 7 | 65% EHA |
| | 20% MMA |
| | 15% AA |
| 8 | 75% EHA |
| | 15% AA |
| | 10% lauryl methacrylate (LMA) |
| 9 | 65% EHA |
| | 15% AA |
| | 20% LMA |
| 10 | 75% EHA |
| | 15% AA |
| | 10% N-vinyl pyrrolidone (NVP) |
| 11 | 75% EHA |
| | 15% AA |
| | 10% isobornyl methacrylate |

Additives, such as pigments, fillers, ultraviolet light absorbers, ultraviolet stabilizers, antioxidants, plasticizers, tackifiers, fire retardant agents, thermally or electrically conductive agents, post curing agents, and the like may be blended into the acrylic based adhesive compositions of the invention to modify the properties of the adhesive. Ultraviolet light absorbers include hydroxyphenyl benzotriazoles and hydrobenzophenones. UV stabilizers are commonly hindered amine light stabilizers. Antioxidants include, for example, hindered phenols, amines, and sulfur and phosphorus hydroxide decomposers, such as Irganox 1520L. Typically, such additives are used in amounts of about 0.1 to about 30 parts per hundred parts of total solids.

The damping acrylic based adhesives of the invention can be used in various adhesive constructions. For example, the adhesive can be applied to a substrate or carrier film. The carrier film may be a polymeric film, such as a polyester, polyethylene, polypropylene, polyurethane, or polyvinyl chloride film or multilayer film or blend of one or more of these. The substrate or carrier film can also be a release liner or a paper substrate. Substrates or carriers include, but are not limited to films, felt, woven, knitted, non-woven, scrim, foamed, or cavitated substrates. Other substrates include, but are not limited to, metal such as aluminum, steel, and stainless steel, with or without a coating overlying the metal. The adhesive construction may be a transfer tape, single coated or double coated construction with one or two liners.

Various release layers are available that may be contacted with the acrylic based adhesives of the invention, and the release layers are useful in protecting the pressure sensitive adhesive from inadvertently bonding prior to use. Suitable release layers are described in some detail in Chapter 23 of the Handbook of Pressure Sensitive Adhesive Technology, 2d Ed., edited by Donatas Satas, and incorporated herein by reference. If an adhesive layer is applied to both sides of a substrate, or a transfer tape is desired, then release layers can be applied to both adhesive layers or sides. These two release layers can be differentially releasable from the adhesive layers to provide additional convenience in application. In one embodiment, the adhesive is coated onto a double sided siliconized liner to produce a transfer tape or a double coated tape.

The material loss factor is one indication of the vibration (and sound) damping properties of a material. The composite loss factor is a measure of the conversion of vibrational energy to thermal energy. A conventional high damping material composition is generally required to have a material loss factor of not less than 0.8. In a constraint layer construction, the total composite loss factor, including the constraint layer substrates and the visco-elastic damping material, is generally required to be not less than 0.1.

The loss factor data are generated from a vibrating beam tester (VBT) available from Damping Technologies Inc., U.S., in accordance with ASTM-E-756-98. Composite loss factors are obtained from the measurement in a sandwich construction, using vibration beams with known material properties. The material loss factor is calculated from this composite loss factor, taking into account the mechanical properties of the sandwich materials used.

In one embodiment, the acrylic based adhesives of the present invention have a material loss factor equal to or greater than about 0.8 at least one frequency in the range of about 100 Hz to about 10 kHz and within a temperature span of at least 25° C. within the temperature region above 25° C. In one embodiment, the adhesive has a material loss factor equal to or greater than about 0.8 at least one frequency in the range of about 100 Hz to about 10 kHz and within a temperature span of at least 35° C. within the temperature region above 40° C. In another embodiment, the adhesive has a material loss factor equal to or greater than about 0.8 at least one frequency in the range of about 100 Hz to about 10 kHz and within a temperature span of at least 35° C. within the temperature region above 70° C.

In one embodiment, the optimum damping temperature is shifted to higher temperatures using the formulations of the present invention. The optimum damping temperatures at 100 Hz and 10 Hz for the products of Examples 1-14 is determined by preparing constructions by casting a film of the wet adhesive products of Examples 1-11 containing aluminum acetylacelonate on a presiliconized paper release liner. The solvent is evaporated in an air ventilated oven at 110° C. for 10 minutes. The dry adhesive coat weight is from 25 to 50 g/m² dependent on the formulation. All of the adhesives of Examples 1-11 have a composite loss factor above 0.1 in a temperature ranged at least 30° C.

The damping properties of the constructions are evaluated according to ASTM-E-756-98 as noted above. The optimum damping temperatures obtained for Examples 1-11 at 100 Hz and 1000 Hz are summarized in Table II.

TABLE II

| | |
|---|---|
| | Optimal Damping |
| Construction of | Temp. (° C.) |

| Example | at 100 Hz | at 100 Hz |
|---|---|---|
| 1 | 32 | 50 |
| 2 | 55 | 75 |
| 3 | 75 | 97 |
| 4 | 45 | 65 |
| 5 | 60 | 80 |
| 6 | 41 | 60 |
| 7 | 50 | 70 |
| 8 | 45 | 66 |
| 9 | 50 | 71 |
| 10 | 65 | 90 |
| 11 | 60 | 80 |

In another embodiment, a high glass transition temperature (Tg) modifying resin may be blended with the above described acrylic copolymers to optimize sound/vibration damping at higher temperatures. As used herein, the term “high Tg” means a glass transition temperature of at least 50° C., and the Tg is measured using the DSC method on a TA Instruments DSC Model 2920 at 5° C./minute temperature increase rate with the samples sealed in an aluminum pan. The amount of modifying resin blended with the acrylic copolymer depends on the desired temperature and frequency range where damping performance is to be optimized. In one embodiment, the amount of the high Tg modifying resin blended with the acrylic copolymer is within the range of about 5 to 60% by weight, based on the total solids. In another embodiment, the amount of high Tg modifying resin blended with the acrylic based copolymer is within the range of about 10 to 40%, or about 20 to 30% by weight based on the total solids.

The glass transition temperature and chemical composition of the modifying resin used depend on the target frequency and temperature range for which optimal sound and/or vibration damping is desired. In addition, the high Tg modifying resin should be blendable with the acrylic based polymer. Examples of useful modifying resins include acrylic resins, copolyester resins, polyurethanes, terpenes, terpene phenolics and derivatives thereof, including hydrogenated and aromatic modified terpenes, rosin including hydrogenated and esterified rosin, polyphenylene ethers, polyketones, coumarone-indene resins, and blends of high Tg resins. In one embodiment, the modifying resin comprises a terpene phenolic resin.

Useful commercially available high Tg acrylic resins include Viacryl SC 108/50T (Tg=57.6° C.) from Solutia, Paraloid B-99 (Tg=82° C.) and Paraloid A-21 (Tg=105° C.) from Rohm and Haas.

Useful commercially available high Tg copolyester resins include the series VITEL brand from Bostik (USA) and the series DYNAPOL brand from Huls AG (Germany). A particularly useful copolyester resin is DYNAPOL S1611 (Tg-50° C.). Other high Tg resins include Reagem 5110, a hydroxylated terpene phenolic resin (Tg=57.3° C.), Dertophene 1510, a terpene phenolic resin (Tg=102.3° C.), both from DRT of France; K-1626, a rosin-ester based resin (Tg=122° C.) from Resolution Specialty Materials of Belgium; and PPO SA 120, a polyphenylene ether (Tg=152° C.) from General Electric Advanced Materials.

Blending of the acrylic copolymer and the modifying resin is done by any method that results in a substantially homogeneous distribution of the acrylic copolymer and modifying resin in the coated adhesive. The blend can be prepared by solvent blending, hot melt blending, emulsifying, etc. In the case of solvent blending, the copolymers should be substantially soluble in the solvents used.

Any suitable solvent may be used to form the modified adhesive copolymer adhesives of the invention. Typical solvents include tetrahydrofuran, toluene, xylene, hexane, heptane, cyclohexane, cyclohexanone, methylene chloride, isopropanol, ethanol, ethyl acetate, butyl acetate, isopropyl acetate and the like.

While the invention has been explained in relation to its various embodiments, it is to be understood that other modifications thereof will become apparent to those skilled in the art upon reading the specification. Therefore, it is to be understood that the invention disclosed herein is intended to cover such modifications as fall within the scope of the appended claims.

1. A self-crosslinked acrylic based adhesive comprising, on a copolymerized basis,
(A) from about 50 to about 90% by weight of at least one alkyl acrylate, alkyl methacrylate, and mixtures thereof, wherein the alkyl group contains at least four carbon atoms,
(B) from about 10% to about 30% by weight of at least one ethylenically unsaturated carboxylic acid or anhydride monomer, and
(C) from about 0 to about 40% by weight of a monoethylenically unsaturated comonomer selected from styrene and substituted styrenes; alkyl acrylates and alkyl methacrylates containing less than 4 carbon atoms in the alkyl group; vinyl acetate; N-vinyl lactams; acrylonitrile; glycidyl containing monomers; hydroxyalkyl; alkoxyalkyl and phenoxyalkyl acrylates and methacrylates wherein the hydroxyalkyl; alkoxyalkyl and phenoxyalkyl groups contain from 2 to about 12 carbon atoms in the alkyl groups and from 1 to about 6 carbon atoms in the alkoxy groups; cyclic and heterocylic acrylates and methacrylates; and mixtures of two or more thereof.

2. The adhesive of claim 1 wherein the alkyl acrylates and alkyl methacrylates of (A) contain from about 4 to about 12 carbon atoms in the alkyl group.

3. The adhesive of claim 1 wherein the ethylenically unsaturated carboxylic acid comonomer (B) comprises acrylic acid or methacrylic acid, the dimers thereof or mixtures of one or more thereof.

4. The adhesive of claim 1 containing from about 0.5 to about 40% by weight of the monoethylenically unsaturated comonomer (C).

5. The adhesive of claim 1 wherein (C) comprises an alkyl acrylate or an alkyl methacrylate wherein the alkyl group contains less than 4 carbon atoms.

6. The adhesive of claim 1 wherein the monoethylenically unsaturated comonomer (C) comprises methyl methacrylate or ethyl methacrylate.

7. The adhesive of claim 1 wherein the monoethylenically unsaturated comonomer (C) is glycidyl acrylate or glycidyl methacrylate.

8. The adhesive of claim 1 wherein the monoethylenically unsaturated comonomer (C) is a cyclic acrylate or methacrylate.

9. The adhesive of claim 1 wherein the monoethylenically unsaturated comonomer (C) is isobornyl acrylate or isobornyl methacrylate.

10. The adhesive of claim 1 wherein the monoethylenically unsaturated comonomer (C) is N-vinyl pyrrolidone.

11. The adhesive of claim 1 wherein the monoethylenically unsaturated comonomer (C) is phenoxyethyl acrylate.

12. The adhesive of claim 1 wherein the monoethylenically unsaturated comonomer (C) is 3,3,5-trimethyl cyclohexyl acrylate or methacrylate.

13. The adhesive of claim 1 wherein the copolymer comprises, on a copolymerized basis, from about 60 to about 85% of (A).

14. The adhesive of claim 1 wherein the copolymer comprises, on a copolymerized basis, from about 15% to about 25% by weight of at least one ethylenically unsaturated carboxylic acid monomer (B).

15. The adhesive of claim 1 wherein the copolymer is free of epoxy monomers.

16. The adhesive of claim 1 which is free of phenolic antioxidants.

17. A self-crosslinked acrylic based adhesive prepared from a monomer mixture comprising
(A) from about 60 to about 85% by weight of at least one alkyl acrylate, alkyl methacrylate, and mixtures thereof, wherein the alkyl group contains from 4 to about 12 carbon atoms.
(B) from about 15 to about 30% by weight of at least one ethylenically unsaturated carboxylic acid or anhydride monomer, and
(C) from about 0.5 to about 25% by weight of a monoethlenically unsaturated comonomer selected from alkyl acrylates and alkyl methacrylates containing less than four carbon atoms in the alkyl group; glycidyl acrylate and glycidyl methacrylate; N-vinyl lactams; hydroxylalkyl, alkoxyalkyl and phenoxyalkyl acrylates and methacrylates wherein the hydroxyalkyl, alkoxyalkyl and phenoxyalkyl groups contain from 2 to about 12 carbon atoms in the alkyl groups and from 1 to about 6 carbon atoms in the alkoxy groups; cyclic and heterocylic acrylates and methacrylates; and mixtures of two or more thereof.

18. The adhesive of claim 17 wherein the ethylenically unsaturated carboxylic acid monomer (B) comprises acrylic acid, methacrylic acid, dimers thereof or mixtures of two or more thereof.

19. The adhesive of claim 17 wherein the monoethylenically unsaturated comonomer (C) is selected from methyl methacrylate, methyl acrylate, and ethyl acrylate, ethyl methacrylate, isobornylacrylate, isobornyl methacrylate, N-vinyl pyrrolidone, and mixtures of two or more thereof.

20. The adhesive of claim 17 wherein the mixture contains a chelate crosslinking agent.

21. The adhesive of claim 17 wherein the mixture contains from about 0.01 to about 1% by weight, based on the total dry weight of monomer and comonomer, of acetylacetonate.

22. The adhesive of claim 17 wherein the mixture is free of phenolic antioxidants.

23. The adhesive of claim 17 wherein the mixture is free of internal crosslinking agents.

24. A sound/vibration damping construction comprising the adhesive of claim 1.

25. A damping adhesive construction comprising
an acrylic copolymer prepared from a mixture comprising
(A) from about 50 to about 90% by weight of at least one alkyl acrylate, alkyl methacrylate, and mixtures thereof, wherein the alkyl group contains at least four carbon atoms,
(B) from about 10% to about 30% by weight of at least one ethylenically unsaturated carboxylic acid or anhydride monomer, and
(C) from about 0 to about 40% by weight of a monoethylenically unsaturated comonomer selected from styrene and substituted styrenes; alkyl acrylates and alkyl methacrylates containing less than 4 carbon atoms in the alkyl group; vinyl acetate; N-vinyl lactams; acrylonitrile; glycidyl containing monomers; hydroxyalkyl, alkoxyalkyl and phenoxyalkyl acrylates and methacrylates wherein the hydroxyalkyl, alkoxyalkyl and phenoxyalkyl groups contain from 2 to about 12 carbon atoms in the alkyl groups and from 1 to about 6 carbon atoms in the alkoxy groups; cyclic and heterocylic acrylates and methacrylates; and mixtures of two or more thereof.

26. The adhesive construction of claim 25 wherein the substrate comprises a release liner.

27. The adhesive construction of claim 25 wherein the substrate comprises a polymeric film.

28. The adhesive construction of claim 25 wherein the substrate comprises a metal.

29. The adhesive construction of claim 25 wherein the construction comprises a transfer tape.

30. A modified damping adhesive comprising a blend comprising
40-95% by weight of the acrylic based adhesive of claim 1 and
5-60% by weight of a thermoplastic modifying polymer having a Tg of at least 50° C.

31. The modified adhesive of claim 30 comprising 10% to about 40% by weight of the modifying polymer.

32. The modified adhesive of claim 30 wherein the modified adhesive has a material loss factor equal to or greater than about 0.8 at at least one frequency in the range of about 100 Hz to about 10 kHz and within a temperature span of at least 35° C. within the temperature region above 35° C.

33. The modified adhesive of claim 30 wherein the modifying polymer comprises an acrylic resin, a polyphenylene ether, a rosin based resin, a polyester copolymer, a terpene, a terpene phenolic based resin, and mixtures of two or more thereof.

34. A damping adhesive construction comprising the modified adhesive of claim 30 and at least one substrate wherein the modified adhesive is adhered to or laminated to the substrate.

35. The construction of claim 34 wherein the substrate comprises a release liner, polymer film or metal.
